(19) United States
(12) Patent Application Publication
(10) Pub. No.: US 2013/0311166 A1
(43) Pub. Date: Nov. 21, 2013

(54) Domain-Specific Natural-Language Processing Engine

(71) Applicant: Andre Yanpolsky, New York, NY (US)

(72) Inventor: Andre Yanpolsky, New York, NY (US)

(21) Appl. No.: 13/650,132

(22) Filed: Oct. 12, 2012

Related U.S. Application Data
(60) Provisional application No. 61/647,167, filed on May 15, 2012.

(51) Int. Cl. G06F 17/28

(52) U.S. Cl. 704/2

(57) ABSTRACT

The present disclosure provides a construction for managing domain specific, configurable natural-language processing. The system described allows for the extraction of entities and other discrete grammar components through a collection of iterative rulesets. Each instance of the parser system may be tailored to the domain of a particular subject of inquiry. Instance-level constraints enable increasingly fine classification on input data. Intuitive rulesets enable instance-level configuration by non-technical clients. A configured instance of the system receives unstructured text inputs and outputs structured data relevant to the domain of the instance.

### CROSS-REFERENCE TO RELATED APPLICATION

This application claims the benefit of U.S. Provisional Application No. 61/647,167, filed May 15, 2012.

### TECHNICAL FIELD

The presently disclosed embodiments relate to converting an input into a computer readable output within an the context of a specific domain, and more particularly to converting a textual input into a well-structured computer-readable output within the context of a specific domain.

### BACKGROUND

For a search engine to work properly, the system must be able to interpret the input from the user and convert that interpretation into something the computer understands to be able to search a database.

In instances where there is a search engine within a web page, that search engine needs to be able to provide results that are relevant to content and user of that web page. Many search engines in this context yield inaccurate results when an input is given that is open to a range of meanings depending on the context or domain. These inaccuracies arise as a result of the search engine not knowing how to interpret the query and the domain owner having no way to modify the search engine to do so.

Existing solutions are primarily keyword based search engines installed into these websites. These search engines apply the same set of searching and parsing rules as they would in their generic setting. Normally, search is conducted based on keywords; existing systems use keyword searches for unstructured requests (natural language). Most information systems also have a database capable of serving data for structured requests (database queries in SQL or any other language).

There exists a need of a solution that provides a more domain-targeted search engine. Further, there is a growing need of a system in which a domain owner would be able to create and modify the rules that the system applies.

### SUMMARY

The present disclosure provides a system for converting a user input into a computer readable output. The system includes an input which intakes a user-entered command or query. The system additionally includes a set of rules to apply to the input. Moreover, the system employs a parser configured to apply the rule set to the input and producing a resultant output. Finally, the system employs an output through which to display the resultant structured set of data from the parser.

One embodiment of the present disclosure provides a method for converting textual natural language commands and queries into a computer-readable, well-structured output. The method includes receiving the command or query from the input and retrieving the applicable rule set. The method further includes parsing the command or query and applying the selected rule set to the parsed command or query. Moreover, the method includes rendering a structured-data output from the aforementioned manipulated command or query input.

Another embodiment of the present disclosure provides a more detailed method for converting textual natural language commands and queries into a computer-readable, well-structured form. It will be understood by those skilled in the art that this method includes that same steps as the method above except the parsing step is broken down into several additional steps. The method includes breaking the command or query into tokens. The method further includes analyzing and correcting those tokens. Further, the method includes detecting topic signals from those tokens and rewriting the tokens to resolve and correct any semantic ambiguities.

### BRIEF DESCRIPTION OF THE DRAWINGS

FIG. 1 schematically illustrates an exemplary system for converting a natural language command or query into a computer readable output through the use of domain specific rules according to an embodiment of the present disclosure.

FIG. 2 illustrates a method for parsing a search query, starting with a user's query as input and ending with relevant data as output.

FIG. 3 illustrates an embodiment of the method pictured in FIG. 2, as applied to the example user query “show me red sneakers under $75”.

FIG. 4 illustrates a cyclical model relating a human user, a parser, and a database; it shows that a user can submit a query and receive data that is relevant to that query.

FIG. 5A and 5B illustrate how the hypothetical user query “mercury after 2006” can be handled differently by different instances of a parser that are optimized for specific domains.

FIG. 6 illustrates a computer network in which a user can search different databases through different sites on a web browser.

FIG. 7 illustrates a method for creating and modifying a custom, domain-specific instance of a parser.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

As used herein, the term, “entity” refers to a data structure representing an object identified by the parser. The term “domain” refers to the subject matter over which a single instance of the parser is functional. The term “ruleset” refers to a collection or grouping of parsing rules or other rulesets. The term “feature” refers to a token, entity, topic, date, number, range, fluff or other attribute identified in an input. The term “fluff” refers to irrelevant tokens that do not contribute to the substance of the user query and domain.

### Overview

Embodiments of the present disclosure describe a system which enables domain-specific conversion of natural language commands and queries into a well-structured, computer-readable output through the use of domain-specific rules. The system intakes the user entered command or query as text or speech and selects the appropriate domain specific ruleset to apply. The domain specific rules are then applied to convert the command or query into a data structure that is optimized for the subsequent database or application operation.

### Exemplary System

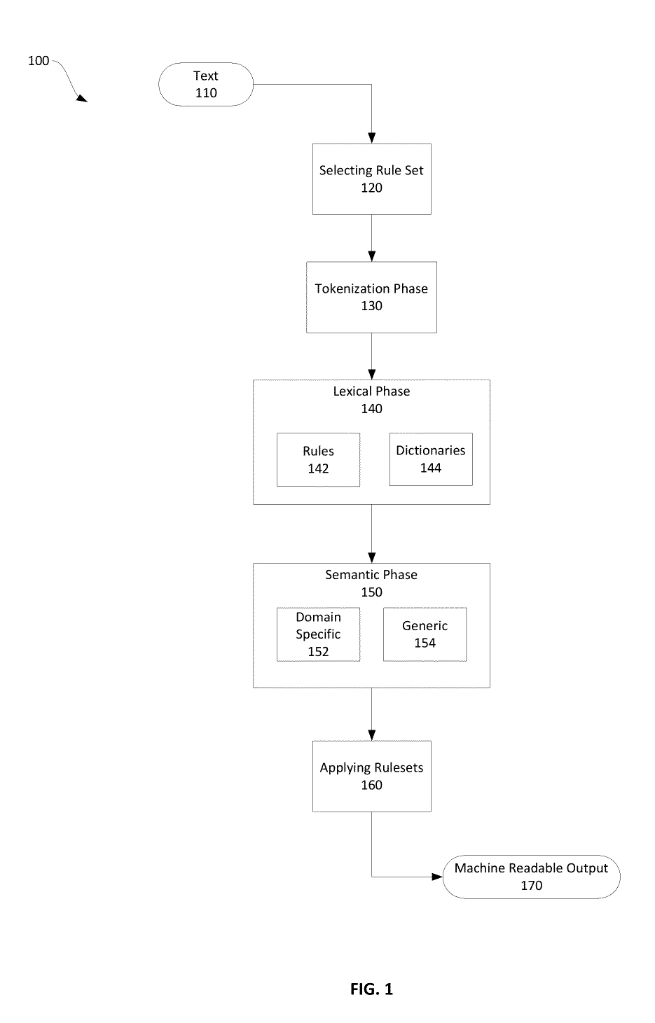

FIG. 1 schematically illustrates an exemplary system 100 which receives a text input 110 and, through an ordered series of operations, creates a machine readable output 170.

The text 110 is fed to a selecting rule set 120 where parsing begins. The text is tokenized 130 into discrete units called tokens. Each token passes through the lexical phase 140 in which rules 142 or dictionary corrections 144 specific to tokens may be applied. The tokens then pass collectively to the semantic phase 150, in which rules are applied to the series of tokens. These rules may be specific to the subject domain 152 or generic 154 and may add structural information to the tokens. Once these rules are applied 160, the output is in machine readable form 170. The machine readable form 170 can be rendered in any common programming language; common programming languages include, but are not limited to, XML, JSON, SQL, and HTML.

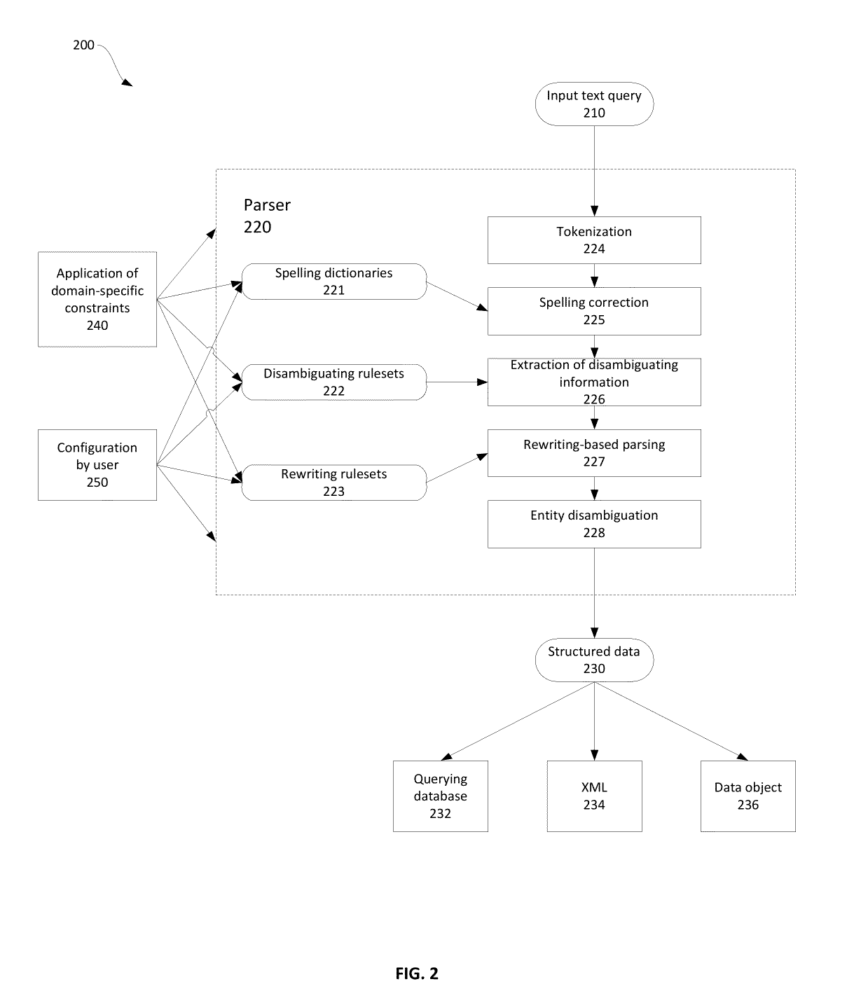

Operation commences to transform an unstructured text input 110 into a machine readable output 170. FIG. 2 schematically illustrates an exemplary method of parsing 200 in which a user submits an input text query 210 and a parser 220 translates the input text query 210 into structured data 230.

The parsing process is influenced by spelling dictionaries 221, disambiguating rulesets 222, and rewriting rulesets 223. These and other elements of the parser are subject to application of domain-specific constraints 240 and configuration by user 250. The user could have advanced knowledge in the field or could be non-technical.

The user query 210 is a string of text that may be entered manually with a device like a keyboard or a touch screen. Alternatively, the user query may be expressed vocally and subsequently translated into text. When the user query 210 is passed to the parser 220, it undergoes a process called tokenization 224, which means it is broken down into discrete units called tokens. These tokens may comprise words, numbers, or individual punctuation characters.

User-specific spelling dictionaries 221 are used to correct the spellings of the results of tokenization 224 and produce 225. Once the spelling of query has been corrected, disambiguating rulesets 222 are utilized in the extraction of disambiguating information 226 and will be saved for use in the entity disambiguation phase 228.

After extraction of disambiguating information 226, rewriting rulesets 223 are applied to the tokenized query in the process of rewriting-based parsing 227. During rewriting-based parsing 227, the tokens of the query are replaced with structured elements including entities, dates, and ranges.

In the process of entity disambiguation 228, the structured elements resulting from the process of rewriting-based parsing 227 are filtered down to query-relevant elements based on the extraction of disambiguating information 226.

The output of the entity disambiguation 228 is structured data 230, which is meant to convey the important information contained in the input text query 210 in a format that can be used to query a database 232, or to return XML 234, or to generate a data object 236.

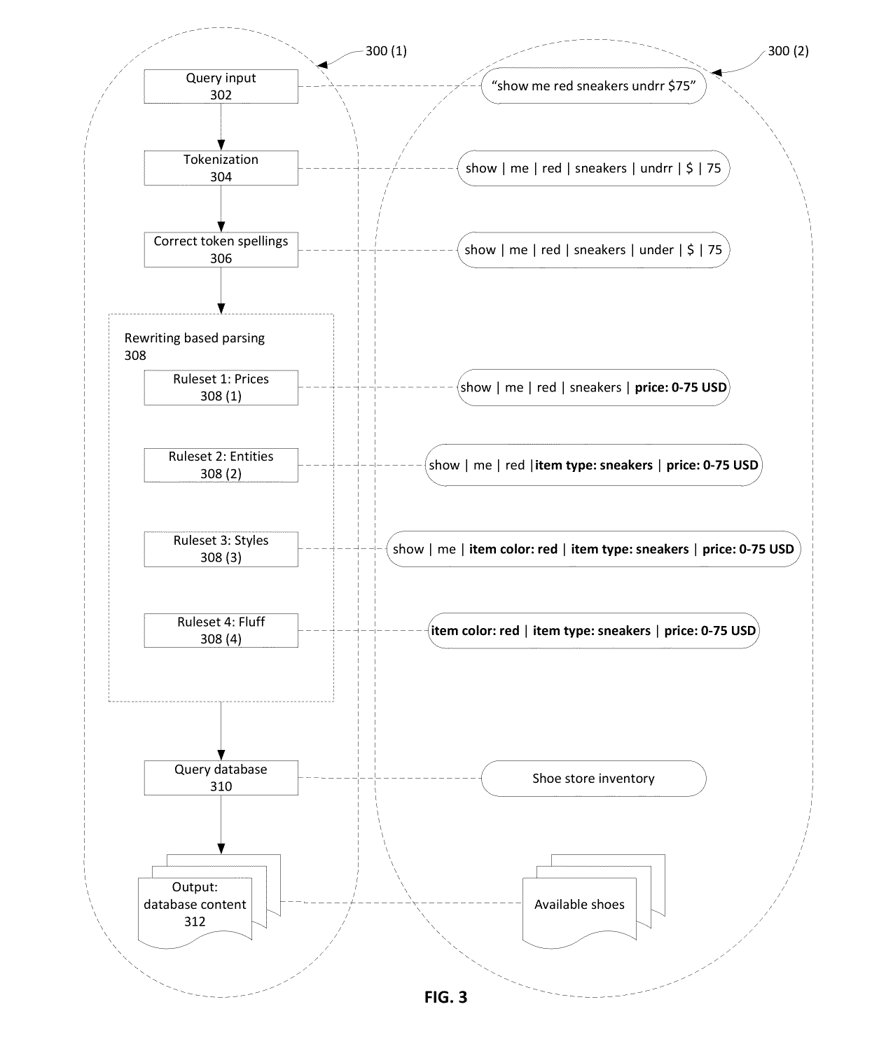

FIG. 3 illustrates a specific example of parsing a query according to the method 200. It will be understood by those skilled in the art that the description corresponding to the method 200 would be similar to the description provided for the objects in FIG. 2 and that extraction of disambiguating information 226 and entity disambiguation 228 have been omitted for simplicity. The simplified method 300 (1) is illustrated in parallel with the specific example 300 (2).

The query input 302 “show me red sneakers undrr $75” is tokenized and results in a tokenized query of seven discrete tokens: “show”, “me”, “red”, “sneakers”, “undrr”, “$”, and “75” 304. The tokenization query 304 is then spell-corrected 306, correcting “undrr” to “under.”

In the rewriting-based parsing 308, a series of rewriting rulesets, 308 (1) through 308(4), are applied. Each ruleset translates some of the tokens into a structured element. Though the order of rules within a ruleset may not matter, the order in which rulesets are applied is potentially consequential: once a rewriting ruleset is applied, it has rewritten the original query according to its rules; its output becomes the input of the subsequent rewriting ruleset.

Ruleset 1: Prices, replaces the tokens “under”, “$”, and “75” with a price range from zero U.S. dollars to 75 U.S. dollars 308 (1). Ruleset 2: Entities, replaces “sneakers” with an entity representing the type of shoe 308 (2). Ruleset 3: Styles, replaces the word “red” with an object representing the color red 308 (3). Ruleset 4: Fluff, removes the tokens “show” and “me”, having identified them as fluff 308 (4).

The output of this chain of rulesets is used to query a database, in this case a shoe store inventory, 310, and to output the relevant database content 312, available shoes.

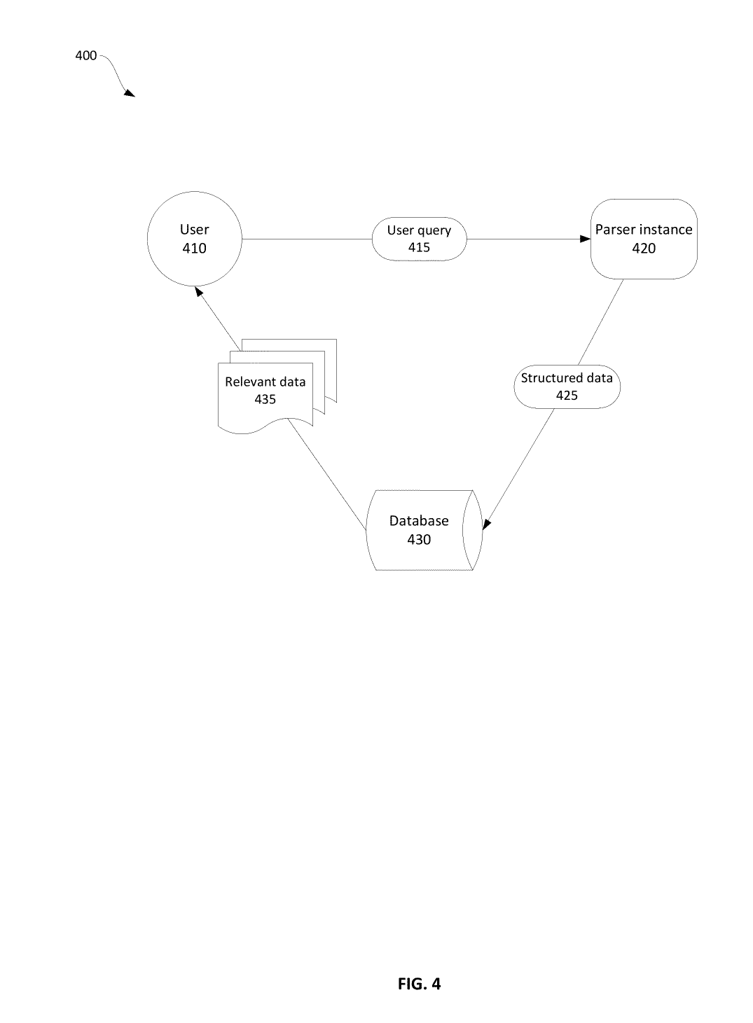

FIG. 4 illustrates shows an embodiment of a three-way relationship 400 among user 410, parser instance 420, and database 430.

A user 410 submits a user query 415; that user query 415 is taken in by a parser instance 420. The parser instance 420 then outputs structured data 425, containing the same important information as the user query 415, but in a machine-readable format that can be used to query a database 430. The action taken by the application or database is not limited to database search, selected here as example, and may include command processing, data entry, or any other application activity. Once the database 430 has been queried, the portion of its data that is relevant to the operation 435 is delivered to the user 410.

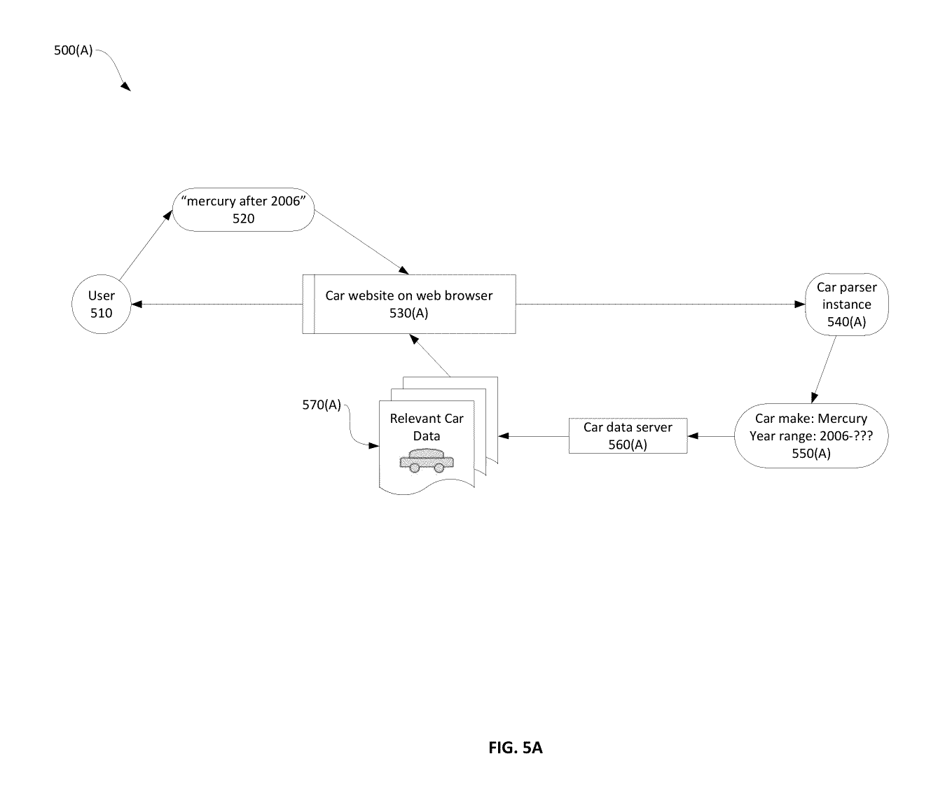

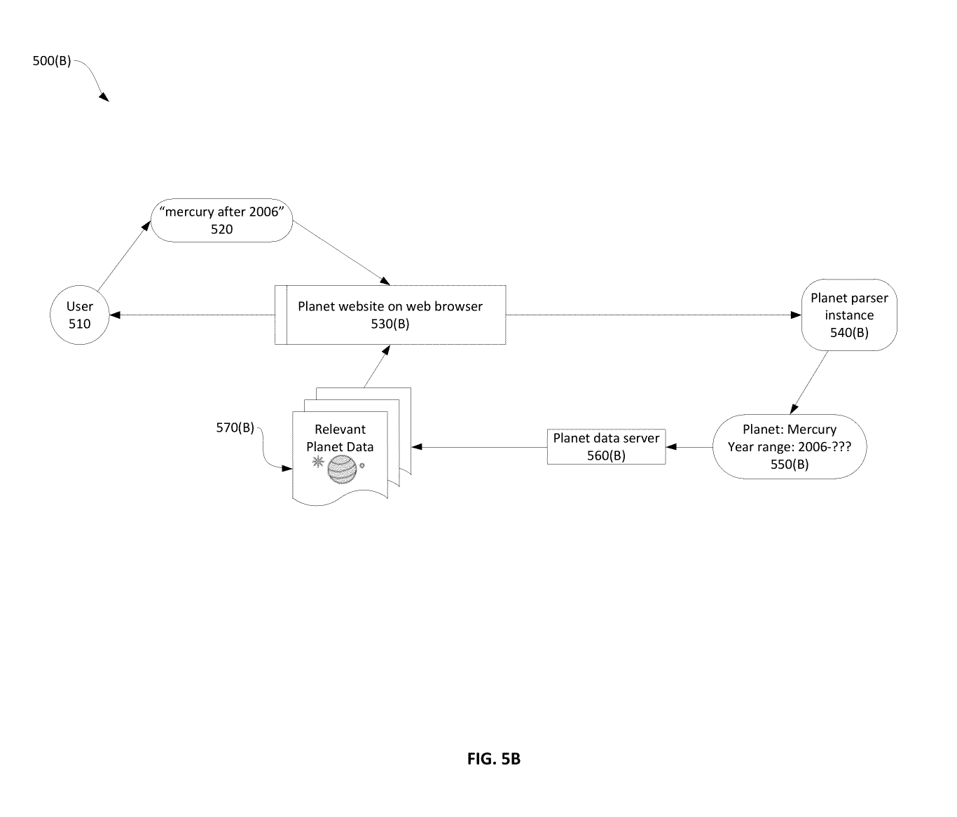

FIG. 5A & 5B: demonstrate domain specific parsing by illustrating how a single query is processed differently in two distinct instances. It will be understood by those skilled in the art that system 500(A) and system 500(B) differ in the domain to which they are individually specific and all remaining elements are comparable.

The user 510 submits a query “mercury after 2006” 520 through a website on a web browser 530. The particular instance of the parser 540 that receives the user query 520 is configured to understand queries within a given domain. The query 520 is parsed and the tokens are translated into structured data 550 by the parser instance 540. This structured data 550 is used to query the domain-specific server 560 and returns domain-specific data 570 for the website on a web browser 530 to convey to the user 510.

The system 500(A) shows how the query “mercury after 2006” 520 is processed when submitted on a car website on a web browser 530(A). The car parser instance 540(A) yields car specific structured data 550(A) of a car make and year range, the token “mercury” is replaced with an object representing the make of car called Mercury, tokens “after” and “2006” are translated into a year range with an undefined end point. The car specific structured data 550(A) is used to query a car data server 560(A) yielding relevant car data 570(A) about Mercury car models released in the year 2006 or later. This relevant car data 570(A) is relayed to the user 510 through the car website on the web browser 530(A).

The system 500(B) shows how the query “mercury after 2006” 520 is processed when submitted on a planet website on a web browser 530(B). The planet parser instance 540(B) yields planetary specific structured data 550(B) of a car make and year range, the token “mercury” is replaced with an object representing the planet closest to the Sun, tokens “after” and “2006” are translated into a year range with an undefined end point. The planet specific structured data 550(B) is used to query a planet data server 560(B) yielding relevant planetary data 570(B) about the planet Mercury from 2006 into the future because there is relevant projected data well beyond the current year. This relevant planetary data 570(B) is relayed to the user 510 through the planet website on the web browser 530(B).

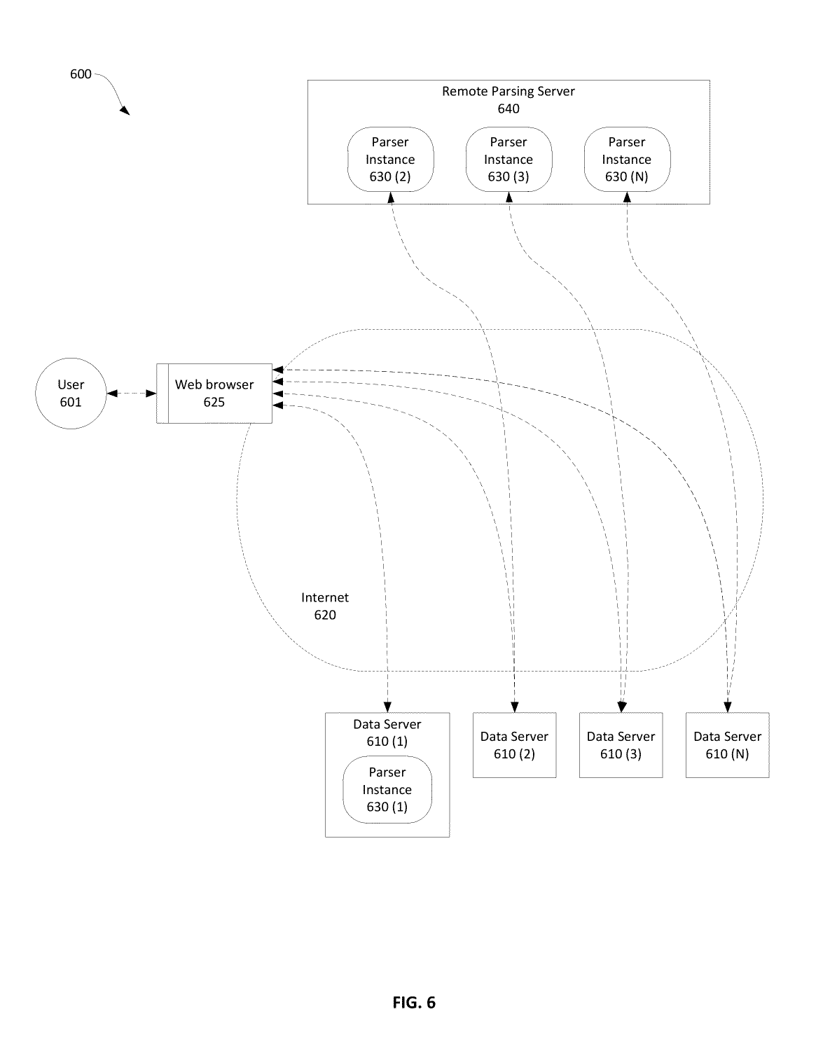

FIG. 6 shows an embodiment of a distributed system 600, the various elements of which may exist across different machines or servers, illustrating that the system can be used to construct a general purpose parser by querying multiple databases (each covering its own domain).

The user 601 communicates with a group of data servers, ranging from 1 to N, through the internet 620 or other network via a web browser 625 or other client application. Each data server may pertain to its own unique domain; for example, Data Server 610 (1) might be delivering real estate data; Data Server 610 (2) might be delivering flight data; and, Data Server 610 (3) might be delivering news content.

Each data server relies exclusively on its own instance of the parser to interpret user queries. For example, Data Server 610 (1) relies on Parser Instance 630 (1) Data Server 610 (2) relies on Parser Instance 630 (2), Data Server 610 (3) relies on Parser Instance 630 (3), Data Server 610 (N) relies on Parser Instance 630 (N), and so on.

The figure shows that a parser instance can be hosted locally on the same server that handles the data, as is the case with Parser Instance 630 (1) running on Data Server 610 (1). Alternatively, a parser instance can run on a remote parsing server 640. Parsing Instance 630 (2), “Parsing Instance 630 (3), and “Parsing Instance 630 (N) fit into this category.

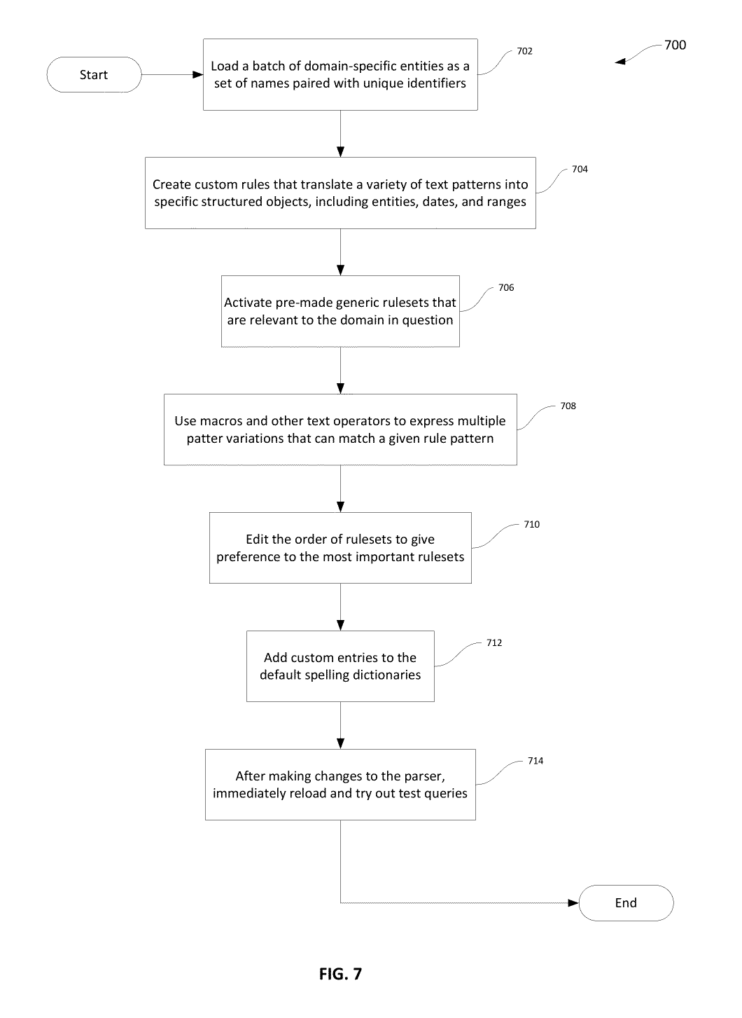

FIG. 7 illustrates an exemplary method 700 for managing and editing a custom parser instance. The overall workflow described allows a user to create a custom parser instance with minimal technical knowledge. Domain-specific entities are batch loaded into the domain parser instance along with their unique identifiers 702. These form the basis of the domain specificity. Subsequently, custom rules can be defined to translate text patterns into structured objects 704, which may include the domain entities 702 or other features. Pre-made generic rulesets 706, such as those for identifying dates and locations, may be incorporated into the domain. These generic rulesets are modular and reusable, and may be selected from a library, rather than recreating them for each relevant domain. Text operators are available to define complex rule patterns efficiently 708. The order of rulesets may be adjusted such that rules may be operate with a desired precedence 710. Spelling dictionaries come equipped with standard words, and can accept the addition of custom entries 712. The combination of the preceding elements defines the custom parser. Alterations to the rules, rulesets, dictionaries, entities and other features may be made and tested in real time 714.

The terminology used herein describes particular embodiments only; considerable variation is anticipated in implementation. It will be appreciated that several of the disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A system for converting textual natural language commands and queries into a computer-readable, well-structured form, the system comprising:
an input for natural language commands or queries;
a set of text processing rules defining how the input will be interpreted;
a parser configured to apply the test processing rules to the input; and
an output to convey a set of structured data provided by the parser.

2. The system of claim 1, wherein the input has multiple interpretations outside of a single domain context.

3. The system of claim 1, wherein the text processing rules are domain specific.

4. The system of claim 1, wherein the text processing rules are defined and stored in a rules management environment.

5. The system of claim 1, wherein the text processing rules define how a set of structural elements will be extracted from the input by matching fragments of text against a predefined set of patterns and replacing these fragments with the structural elements.

6. The system of claim 1, wherein the parser is configured to process lexical information and apply the text processing rules to the input.

7. The system of claim 1, wherein the parser comprises:
a tokenization phase;
a lexical phase; and
a semantic phase.

8. The system of claim 1, wherein the structured output data can be written in any common programming language.

9. A method for converting textual natural language commands and queries into a computer-readable, well-structured form, the method comprising:
receiving a natural language command or query from an input;
retrieving a text processing rules set from a rules processing environment;
parsing the natural language command or query;
applying the selected text processing rules set to the parsed natural language command or query; and
rendering a structured-data output.

10. The system of claim 10, wherein the parsing step includes/comprises:
breaking the natural language command or query into tokens;
analyzing and correcting the tokens;
detecting topic signals based on pattern matching; and
rewriting to resolve semantic ambiguities.

11. The system of claim 10, wherein the rules are applied in an ordered, iterative fashion, wherein the system applies rules until no more rules may be applied.

12. A method for converting textual natural language commands and queries into a computer-readable, well-structured form, the method comprising:
receiving a natural language command or query from an input;
retrieving a test processing rules set from a rules processing environment;
breaking the natural language command or query into tokens;
analyzing and correcting the tokens;
detecting topic signals based on pattern matching;
rewriting to resolve semantic ambiguities;
applying the selected text processing rules set to the parsed natural language command or query; and
rendering a structured-data output.

13. The method of claim 12, wherein tokens are analyzed and corrected by first identifying the origin language of the tokens, then selecting the language-specific spell correct dictionary, then applying that selected dictionary to make the necessary corrections.

14. The method of claim 12, wherein the topic signals are detected through applying topic-detecting rulesets.

15. The method of claim 12, wherein the structured-data output is rendered as structured data in any common programming language.
